(19) United States
(12) Patent Application Publication
(10) Pub. No.: US 2017/0160903 A1
(43) Pub. Date: Jun. 8, 2017

(54) Methods and Systems for Appending a Graphic to a Digital Message

(71) Applicant: Codeq LLC, Apex, NC (US)

(72) Inventors: Paulo Malvar FERNÁNDEZ, La Mesa, CA (US); Douglas Dane BAKER, Cary, NC (US); Russ SMITH, San Francisco, CA (US)

(21) Appl. No.: 15/368,814

(22) Filed: Dec. 5, 2016

Related U.S. Application Data
(60) Provisional application No. 62/263,321, filed on Dec. 4, 2015.

(51) Int. Cl. G06F 3/0481; G06F 17/21; G06F 17/27

(52) U.S. Cl. CPC G06F 3/04817; G06F 17/279; G06F 17/21

(57) ABSTRACT

Systems and methods for appending one or more graphics to a digital message are disclosed. In one embodiment, a method for appending one or more graphic to a digital message may include (1) receiving a digital message; (2) applying natural language processing to the digital image by at least one computer processor; (3) appending one or more graphic to the digital message based at least in part on the natural language processing; and (4) outputting the digital message with one or more appended graphic.

### CROSS-REFERENCE TO RELATED APPLICATION

This application claims priority to U.S. Provisional Patent Application Ser. No. 62/263,321, filed Dec. 4, 2015, the disclosure of which is hereby incorporated, by reference, in its entirety.

### BACKGROUND OF THE INVENTION

1. Field of the Invention

The present invention relates generally to a method and system for appending one or more graphic to digital message notifications or messages themselves based on the context and content of the message.

2. Description Of The Related Art

Information is shared digitally at an ever increasing rate. A quick visual indicator as to the content of shared information may be desirable.

### SUMMARY OF THE INVENTION

Embodiments disclosed herein relate to the systems and methods for appending an graphic to digital message notifications or messages themselves based on the context and content of the message.

Systems and methods for appending one or more graphic to a digital message are disclosed. In one embodiment, a method for appending one or more graphic to a digital message may include (1) receiving a digital message; (2) applying natural language processing to the digital message by at least one computer processor; (3) appending one or more graphic to the digital message based at least in part on the natural language processing; and (4) outputting the digital message with one or more appended graphic.

In one embodiment, the digital message may be received from a sending device.

In one embodiment, the output digital message with one or more appended graphic may be displayed on an electronic receiving device.

In one embodiment, the processed digital message may be stored in a database.

In one embodiment, the natural language processing may determine a context of the digital message.

In one embodiment, the one or more graphic may be selected based on the context of the digital message.

In one embodiment, the natural language processing may determine a category classification of the digital message.

In one embodiment, one or more graphic may be selected based on the category of the digital message, and one or more graphic may be selected based on the context of the digital image.

In one embodiment, the color of the one or more graphic may be based on the context of the digital message.

In one embodiment, a graphic selected based on the context of the digital message may be from a group of graphics preselected by a user of the electronic receiving device.

In one embodiment, the digital message may be an email.

In one embodiment, the digital message may be a notification of an email.

In one embodiment, the digital message may be a push notification.

In one embodiment, the push notification may be based on an action of the electronic receiving device user.

In one embodiment, the digital message may be a text message.

In one embodiment, the one or more graphic may be appended to a representation of the email in an email inbox.

In one embodiment, the one or more graphic may be appended adjacent to the email subject line.

In one embodiment, the one or more graphic may be appended adjacent to a synopsis of the email resulting from the natural language processing.

In one embodiment, the one or more graphic may be appended adjacent to one or more email excerpts selected based on the natural language processing.

In one embodiment, a system for creating appended graphics to a digital message or digital message notification may include (1) a sender device that creates and sending a digital message; (2) a message server that transmits the digital message over a network; (3) a business logic server including a natural language processing service that processes the digital message to append one or more graphic, said one or more graphic being contextually relevant to the digital message, and one or more databases for storing the message and processing results; (4) an electronic receiving device, that receives and displays the processed message; and (5) a push service that delivers the processed message to the electronic receiving device.

A method and apparatus is disclosed that appends one or more of a unicode character, image, emoji, pictograph, photo, icon, symbol, number, or letter (hereafter “graphic”) to structured text data based on lexical analysis of source content. Structured data is ingested or received from a source content provider and is processed to identify and categorize the email into succinct categories based on the email's source, sender, recipient, origin, language, mood, tone, and/or root meaning, for example. Once processing is complete the source content is stored by a business logic server in a database table along with values denoting heuristics about source content. When new content arrives from the source content provider these values are used to determine the appropriate graphic to append to the source content and trigger delivery of a structured text blob (or indeterminately sized structured text string) with the appended graphic to a push service. The structured text string may comprise a summary of the email, an initial portion of the email, or excerpts of the email, for example.

While the application refers to “emails,” it should be appreciated that any message may be analyzed and a corresponding graphic may be appended to such message. Other types of messages may include text messages, alerts, app notifications, voicemail notifications, missed call notifications, calendar notifications, weather notifications, location notifications (for example, based on the user's current, anticipated, or past location, or the location of another person related to the user or in the user's contact list), advertisement messages, security notifications, emergency notifications, task notifications, reminder notifications, financial notifications such as stock updates, website notifications (e.g., from websites recently visited by the user), or notifications from particular applications stored on the user's computing device.

One purpose behind appending a graphic to a particular notification or message is to allow the user to determine at a glance what the message or notification is about without having to actually read the message or notification. By seeing the graphic, the user may know nature, content, or purpose of the message or notification, even without reading the message or notification. While the description herein describes the graphic as being appended to the notification, for example, in an alternative embodiment the graphic may take the place of the notification entirely. In such manner, the user may still be able to know the nature, content, or purpose of the underlying message or notification and valuable screen space may be saved. Such an embodiment may be particularly useful when the display of the device is small compared to other computing devices (e.g., a wristwatch display compared to a laptop screen), or in situations where the user cannot take the time to read a notification or message (such as while driving or when viewing a display in a vehicle, for example).

In one embodiment, the system automatically categorizes messages and/or message content into a category—for example a Facebook message may be categorized into a “Social” category—and assigns a pre-determined character, for example a “champagne” graphic, and appends that character to the notification (e.g., as the first character in a push notification of an email to a user's computing device).

In one embodiment, the system may assign a pre-determined character or a user may select a custom character to apply to one or more categories of content. For example, a “speech bubble” graphic could be applied to notifications for emails auto-assigned by the system to a “Forums” category.

In another embodiment, the system may assign a pre-determined character or the user may select a custom character to apply to notifications of content originating from one or more individuals, organizations, or entities. For example, a “heart” graphic could be applied to notifications for an email originating from their significant other or from one or more members of the user's family, and a “dollar sign” graphic could be applied to a message from a financial entity associated with the user.

In another embodiment, the system may assign a pre-determined character or the user may select a custom character to apply to notifications of content originating from one or more apps or categories of apps. For example, a “video game joystick” graphic could be applied to notifications for video game-related content or to notifications from gaming applications installed on the user's device.

In another embodiment, the system may assign a pre-determined character or the user may select a custom character to apply to notifications of content originating from one or more specific recipients. For example, a “book” graphic could be applied to notifications for an email originating from a social network, such as Facebook, or from a book club the user is a member of.

In another embodiment, the system may assign a pre-determined character or the user may select a custom character to apply to notifications of content originating from one or more specific apps or applications. For example, a “music note” graphic could be applied to notifications originating from a music-playback app such as iTunes® or Google Play®.

In another embodiment, the system may assign a pre-determined character or the user may select a custom character to communicate specific categories or subject matter or types of content. For example, a system could automatically select and apply a “sun and clouds” graphic to apply to notifications for content containing weather forecast-related data.

In another embodiment, the system may assign a pre-determined character or the user may select a custom character to communicate specific words or phrases contained within the content for which the notification is generated. For example, the system could automatically select and apply an “umbrella” graphic to notifications for weather forecast information indicating that the user may need an umbrella soon (e.g., a forecast of rain).

In another embodiment, the system may assign a pre-determined character or the user may select a custom character based on actions of the notification recipient user. For example, a “lollipop” graphic could be applied to notifications for food recipe-related emails the user has, in the past, filed in a “recipes” folder.

In another embodiment, the system may assign a pre-determined character or the user may select a custom character based on actions of a system or a program, such as the operating system or a program on the user's device. For example, a “cake” graphic could be applied to notifications for recipe-related emails that are automatically filed, by the user's operating system or mail application using a custom email filter, in a “recipes” folder.

In another embodiment, the system may assign a pre-determined character or the user may select a custom character based on specific search word(s) or phrase(s) found in the originating content or notification. For example, a “clock” graphic could be applied to notifications or originating content containing the phrase “I'm going to be late”. Different colors of the graphic may also be used based on the context or content of the email. For example, if originating content contains the phrase “I'm going to be late,” a red clock graphic may be appended to the notification; alternatively, if the originating content contains the phrase “I'm going to be early,” a green clock graphic may be appended to the notification. And with reference to the example above regarding a “dollar sign” graphic, the dollar sign may be green when the message from the financial entity pertains to a deposit (or credit) into one of the user's accounts, or the dollar sign may be red when the message pertains to a withdrawal (or debit) from one of the user's accounts. In such manner, the nature of a particular graphic may be changed based on the content of the message, in addition to the type of graphic itself.

In each case where the user selects a customer character or graphic for the particular situation (examples of which are explained above), the user does so before the particular situation occurs. For example, the user would select a customer character before a notification or original content (e.g., an email or message) is received, or before an action takes place (e.g., before a filter is applied to a particular message, or before originating content is categorized, or before an application on the user's device takes some action such as sending a notification).

In cases where the system assigns a pre-determined character or graphic to a notification or original content, this may occur automatically and without user action. Further, the system may determine what character or graphic to append based on the content of the notification or original content using, for example, natural language processing and/or categorization. Such natural language processing and categorizing techniques are described in the application entitled “Method and System for Summarizing Emails and Extracting Tasks,” (Attorney Docket No. 81544.000018) filed on Dec. 4, 2015. Alternatively, the system may determine what character or graphic to append based on some characteristic of the notification such as the time of receipt or any other distinguishing feature.

As shown in FIG. 2, the graphic may be appended to the front of the push notification on a lock screen of the user's computing device (e.g., a smartphone). In one embodiment, the graphic may only be applied and visible in the notification itself and may not be present in, or appended to, the original email content. In other words, in one embodiment the user would not see the graphic in the email itself or in an email app after opening up the email via the notification. In another embodiment, the graphic may be appended to the original email content, such as appended to the beginning of the email or within a subject line of the email, for example. Thus, in this latter embodiment, the user may see the graphic in the notification and in the email itself after opening up the email via the notification or via the messaging app.

In one embodiment, the graphic that is selected to be appended to the message notification may be selected based on a predetermined mapping between an identified email category and one or more graphic. The category of a particular email may be identified by analyzing the content and context of the email (e.g., source, origin/sender, destination, intended recipient(s), mood, tone, and/or root meaning of the message). Such identification may be performed by the system using lexical analysis of the content of the message, as described, for example, in the application entitled “Method and System for Summarizing Emails and Extracting Tasks,” (Attorney Docket No. 81544.000018) filed on Dec. 4, 2015.

### BRIEF DESCRIPTION OF THE DRAWINGS

FIG. 1 is an exemplary system diagram of an embodiment of the present invention;

FIG. 2 is an example of appended graphics to email notifications on a user's mobile device, according to an embodiment of the present invention.

FIGS. 3-6 provide additional examples of how graphics may be appended to email messages or notifications, according to various embodiments of the present invention.

### DETAILED DESCRIPTION OF PREFERRED EMBODIMENTS

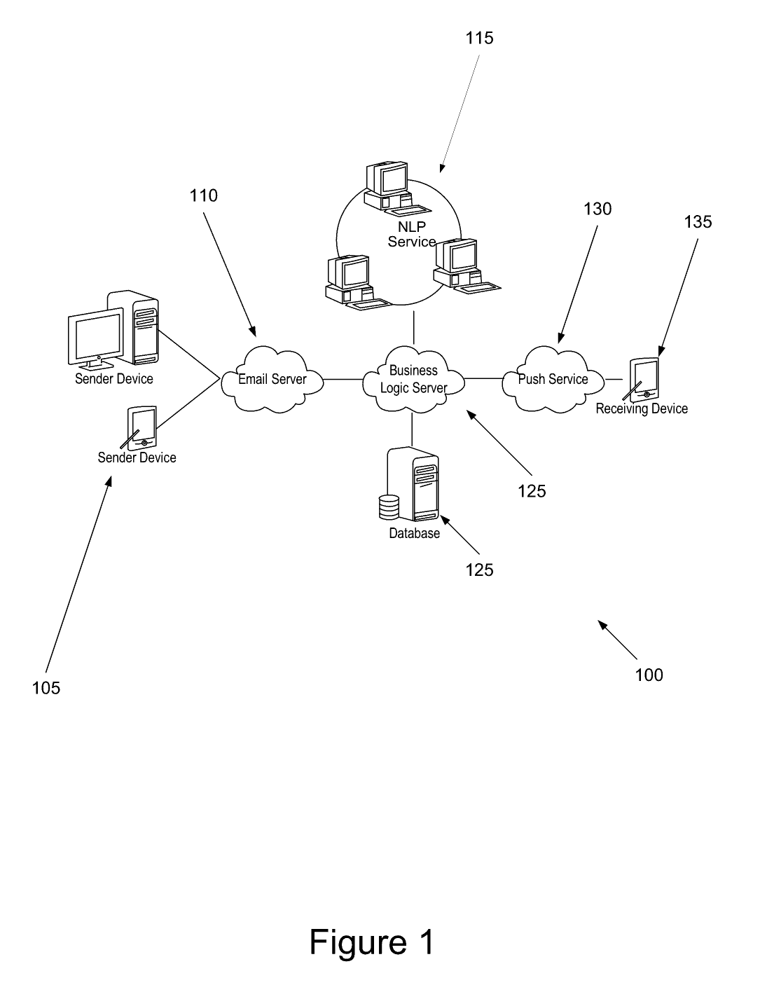

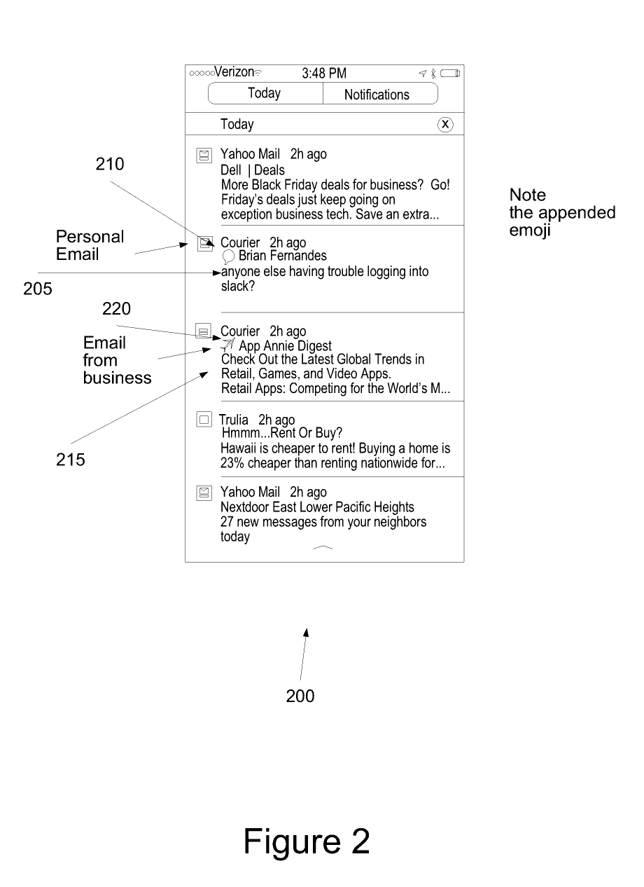

Referring to FIG. 1, one embodiment of an graphic creation system for emails 100 is depicted. System 100 may include a sender device 105 which may send a message, such as an email, to a recipient via email server 110. The message may be received by business logic server 120 from email server 110. Business logic server 120 may be communicatively coupled to natural language processing (NLP) service 115 and one or more databases 125. The NLP service 115 may process the message using natural language processing to determine the source, origin, destination, intended recipient(s), mood, tone, and/or root meaning of the message. The NLP service 115 may rely on information in database 125 for such processing. After analyzing the message, the NLP service 115 or push service 130 may append one or more graphic to the message based on the determined source, destination, root meaning, etc., of the message. Alternatively, business logic server 120 may append one or more graphic to the message based on a characteristic of the message such as a time of receipt, time of message creation, etc. The graphic may be appended to the message itself, to a subject of the message, and/or to a notification that includes a portion of the original message, as shown, for example, in FIG. 2. Alternatively, the graphic itself may be used as a notification of the message. Push Service 130 may then “push” the message to the user's receiving device 135. Receiving device 135 may comprise a smartphone, tablet, laptop, watch, smart glasses, heads-up-display, vehicle dashboard display, desktop computer, etc.

Referring to FIG. 2, a notification screen 200 on a receiving device 135 is depicted. The notification screen includes personal email notification 205 and business email notification 215. One or more graphic may be appended to personal email notification 205, business email notification 215, or any other notification by NLP Service 115 or Push Service 130, for example. FIG. 2 shows “speech bubble” Graphic 210 appended to personal email notification 205 from a person named “Brian Fernandes.” Graphic 210 is shown to be appended next to the sender's name, though the graphic may appear in other locations, such as within a subject line of the message, within an initial portion of the body of the message (such as the first one or two sentences of the message). Graphic 210 may also appear with a summary of the message. The summary may be generated as described in the application entitled “Method and System for Summarizing Emails and Extracting Tasks,” (Attorney Docket No. 81544.000018) filed on Dec. 4, 2015. Alternatively, the graphic may appear alone. Graphic 210 may be selected based on some relationship or relevance to the context of the underlying email, that context may be determined by NLP Service 115.

FIG. 2 also shows “airplane” graphic 220 appended to an email notification from a business 215. Airplane graphic 220 may have been automatically selected by the NLP Service 115 based on a lexical analysis of the message underpinning business notification 215, or a category assigned to the message underpinning business notification 215. In this case, the message may have been assigned to a “business” category or a “botmail” category based on the identity of the sender or the content of the message itself. Alternatively, the user may have assigned “plane” graphic 220 to any messages received from a particular sender or to any messages pertaining to travel, for example. The graphics may be retrieved from database 125 shown in FIG. 1, for example, and/or may be stored locally on the receiving device 135.

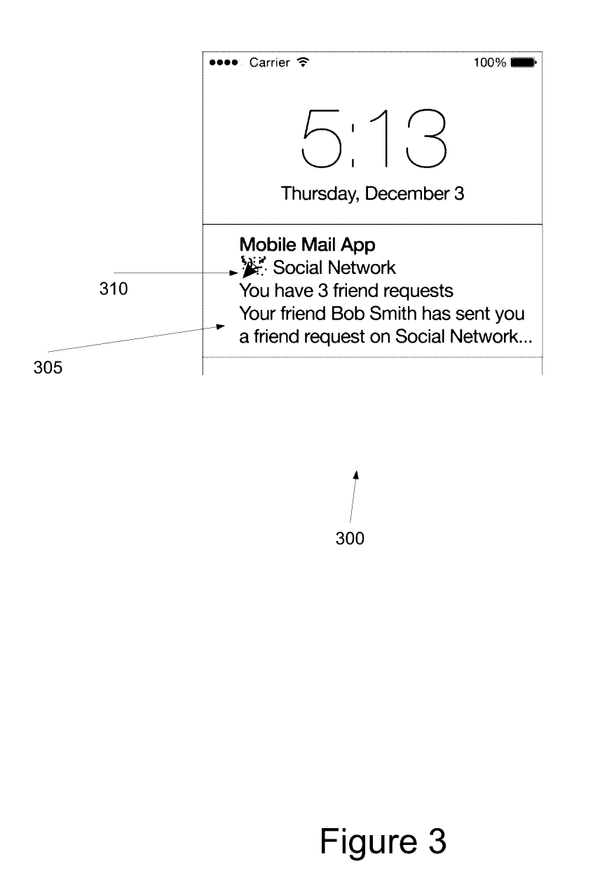

Referring to FIG. 3, a screen 300 on a receiving device 135 is shown. Screen 300 includes notification 305. Notification 305 may be a push notification or any other form of information displayed to a user, such as a pending friend request on a social media website. “Party” graphic 310 may be appended to notification 305. Notification 305 and graphic 310 may include the similar potential functionality as described in connection with email notifications 205 and 215 and graphics 210 and 220.

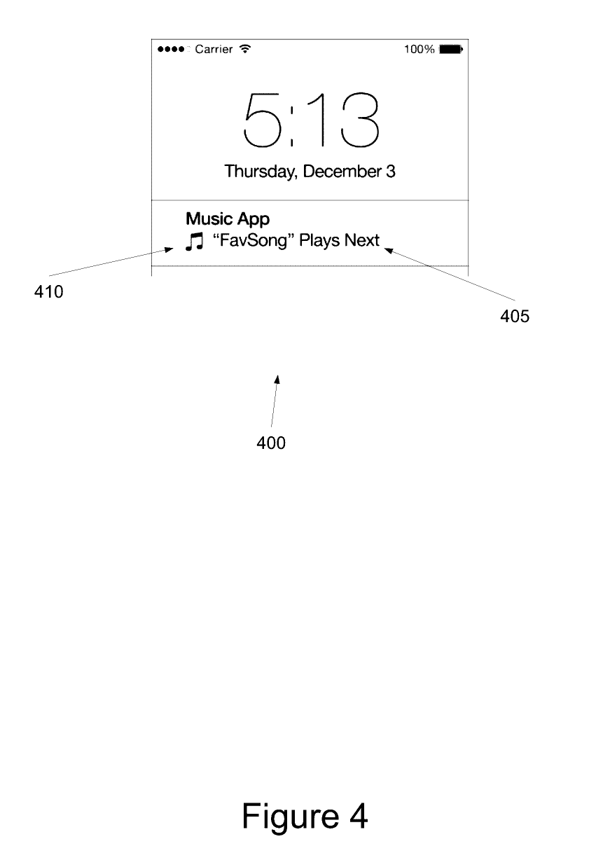

Referring to FIG. 4, a screen 400 on a receiving device 135 is shown. Screen 400 includes notification 405. Notification 405 may be a push notification or any other form of information displayed to a user, such as an action taken, or to be taken, by a software application. “Musical note” graphic 410 may be appended to notification 405. Notification 405 and graphic 410 may include the similar potential functionality as described in connection with email notifications 205 and 215 and graphics 210 and 220.

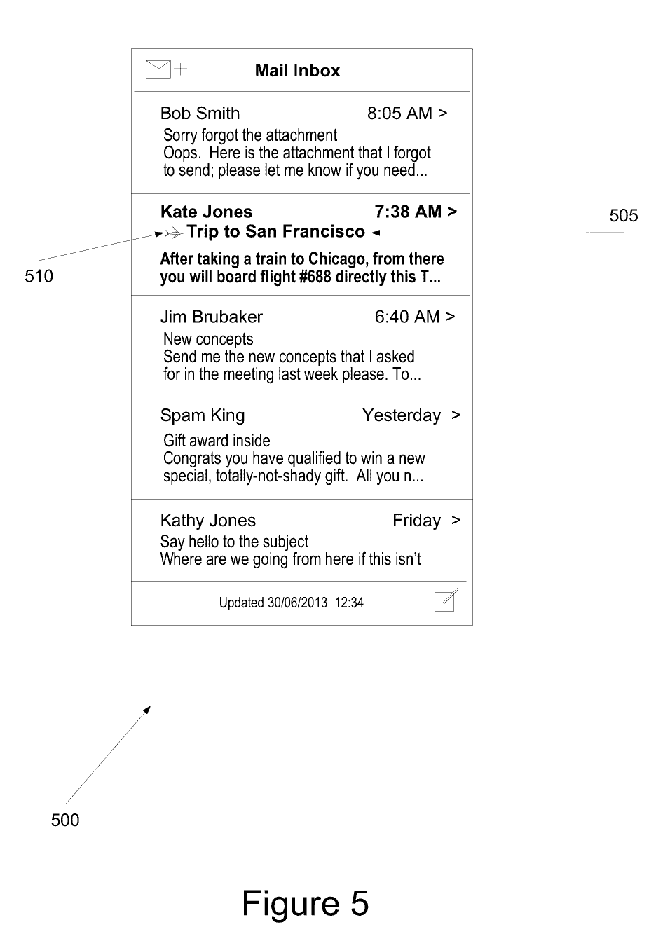

Referring to FIG. 5, an email inbox screen 500 on a receiving device 135 is shown. Screen 500 includes email notification 505. Email notification 505 may be any type of email in an email inbox. “Airplane” graphic 510 may be appended to notification 405. Email notification 505 and graphic 510 may include the similar potential functionality as described in connection with email notifications 205 and 215 and graphics 210 and 220.

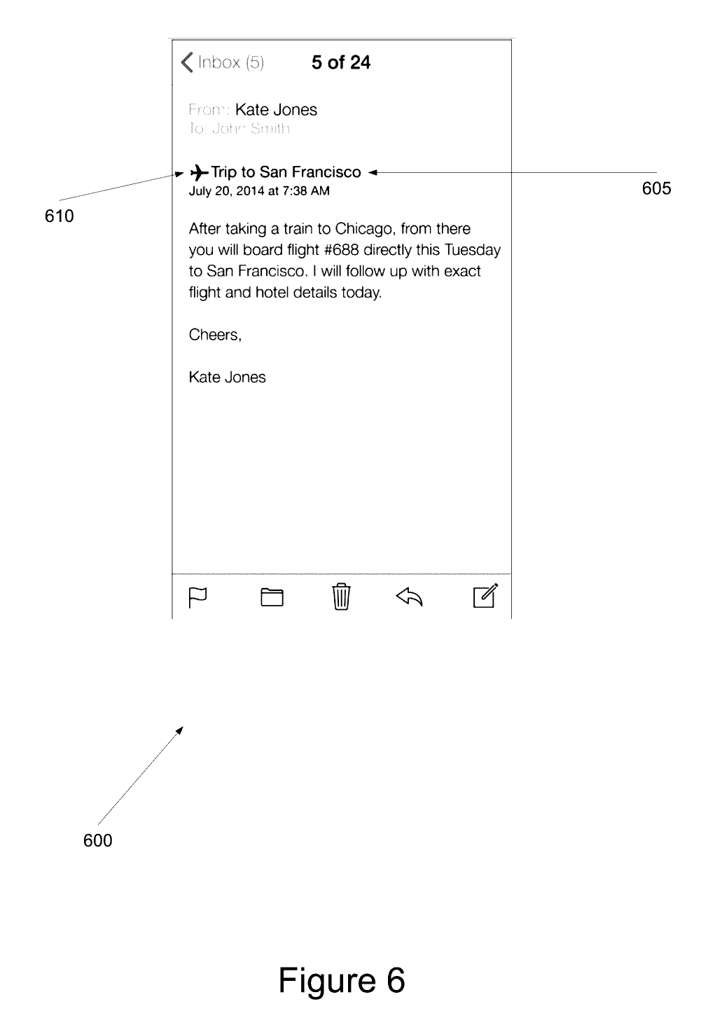

Referring to FIG. 6, an email 600 is displayed on the screen of a receiving device 135. Email 600 includes “airplane” graphic 605. “Airplane” graphic 605 may be appended to any portion of email 600. Email 600 and graphic 605 may include similar potential functionality as described in connection with email notifications 205 and 215 and graphics 210 and 220.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The disclosures of U.S. patent application Ser. Nos. 14/959,331 and 15/131,997 are hereby incorporated, by reference, in their entireties.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for creating appended graphics to a digital messages or digital message notifications comprising:
receiving a digital message;
applying natural language processing to the digital message by at least one computer processor;
appending one or more graphic to the digital message based at least in part on the natural language processing; and
outputting the digital message with the one or more appended graphic.

2. The method of claim 1, wherein the appended graphic is an emoji.

3. The method of claim 1, wherein the digital message is received from a sending device.

4. The method of claim 1, wherein the output digital message with one or more appended graphic is displayed on an electronic receiving device.

5. The method of claim 1, wherein the processed digital message is stored in a database.

6. The method of claim 1, wherein the natural language processing determines a context of the digital message.

7. The method of claim 6, wherein the one or more graphic is selected based on the context of the digital message.

8. The method of claim 6, wherein the natural language processing determines a category classification of the digital message.

9. The method of claim 8, wherein one or more graphic is selected based on the category of the digital message, and one or more graphic is selected based on the context of the digital image.

10. The method of claim 6, wherein the color of the one or more graphic is based on the context of the digital message.

11. The method of claim 7, wherein the graphic selected based on the context of the digital message is from a group of graphics preselected by a user of the electronic receiving device.

12. The method of claim 4, wherein the digital message is an email.

13. The method of claim 4, wherein the digital message is a notification of an email.

14. The method of claim 4, wherein the digital message is a push notification.

15. The method of claim 14, wherein the push notification is based on an action of the electronic receiving device user.

16. The method of claim 4, wherein the digital message is a text message.

17. The method of claim 4, wherein the one or more graphic is appended to a representation of the email in an email inbox.

18. The method of claim 4, wherein the one or more graphic is appended adjacent to the email subject line.

19. The method of claim 4, wherein the one or more graphic is appended adjacent to one or more email excerpts selected based on the natural language processing.

20. A system for creating appended graphics to a digital message or digital message notification comprising:
a sender device that creates and sends a digital message;
a message server that transmits the digital message over a network;
a business logic server including;
a natural language processing service that processes the digital message to append one or more graphic, said one or more graphic being contextually relevant to the digital message;
one or more databases that store the message and processing results;
an electronic receiving device that receives and displays the processed message; and
a push service capable of delivering the processed message to the electronic receiving device.

21. A method for creating appended graphics to a digital messages or digital message notifications comprising:
receiving a digital message;
appending one or more graphic to the digital message based at least in part on a characteristic of the digital message; and
outputting the digital message with the one or more appended graphic.

22. The method of claim 21, wherein the characteristic is a time of receipt.
